(19) United States
(12) Patent Application Publication
(10) Pub. No.: US 2026/0358245 A1
(43) Pub. Date: Nov. 12, 2026

(54) SYSTEM OF H2O2 MEASUREMENT AND METHOD THEREFOR

(71) Applicant: KLA Corporation, Milpitas, CA (US)

(72) Inventors: Eugene SHALYT, Washington Township, NJ (US); Chuannan Bai, Bridgewater, NJ (US); Mainak Dhar, Bloomfield, NJ (US)

(73) Assignee: KLA Corporation, Milpitas, CA (US)

(21) Appl. No.: 19/455,467

(22) Filed: Jan. 21, 2026

Related U.S. Application Data
(60) Provisional application No. 63/802,062, filed on May 8, 2025.

(51) Int. Cl. G01N 21/359; G01N 21/33; G01N 21/3577; G01N 21/65; G01N 31/16; G01N 31/22

(52) U.S. Cl. CPC G01N 21/359; G01N 21/33; G01N 21/3577; G01N 21/65; G01N 31/16; G01N 31/228

(57) ABSTRACT

The disclosed subject matter includes systems for measuring hydrogen peroxide (H₂O₂) concentration, and method therefor. The systems include a non-reagent module configured to continuously generate a first H₂O₂ concentration measurement result using a reagent-free detection measurement; a reagent-based module configured to intervalley generate a second H₂O₂ concentration measurement result using a reagent-involving measurement; a fluidic unit configured to provide the process solution to both the non-reagent analytical module and the reagent-based analytical module; and a processing unit configured to calibrate the first H₂O₂ concentration measurement at each interval of the second H₂O₂ concentration measurement.

### CROSS-REFERENCE TO RELATED APPLICATIONS

This U.S. Non-Provisional application claims priority from U.S. Provisional Application No. 63/802,062, filed on May 8, 2025, hereby incorporated by reference in its entirety.

### BACKGROUND

The disclosed subject matter relates generally to chemical analytical processes, and more particularly, to systems and methods for measuring Hydrogen Peroxide (H₂O₂) concentration in a process solution.

In semiconductor fabrication, H₂O₂ is a commonly used component in many wet clean chemistries due to its strong oxidative properties. It is frequently blended with acidic or basic components to formulate precise cleaning solutions. Accurate control of H₂O₂ concentration is essential, as deviations in concentration can lead to insufficient cleaning, surface damage, or changes in surface roughness—all of which can impact device yield and performance. However, H₂O₂ is inherently unstable and prone to decomposition over time, particularly when exposed to light, heat, or catalytic materials. This instability necessitates frequent monitoring of its concentration during chemical processes.

Certain methods for measuring H₂O₂ concentration include UV-Visible (UV-VIS) spectroscopy, Near Infrared (NIR) spectroscopy, Raman spectroscopy, chemical titration, and reagent-based spectroscopy. Each of these above methods can present limitations that restrict suitability for high-precision process control in a semiconductor manufacturing environment. For example, UV-VIS spectroscopy is prone to signal interference from other chemical species present in the process matrix, which reduces measurement specificity and accuracy. NIR spectroscopy can offer a detection accuracy limited to about ±0.1 wt. %, which is inadequate for applications requiring tighter control windows. Raman spectroscopy similarly can suffer from limited accuracy and be ineffective for detecting subtle changes in H₂O₂ concentration below 0.1 wt. %. Chemical titration, while accurate, can be a time-consuming and labor-intensive process that requires trained personnel and incurs additional costs for reagents and equipment. It is not suitable for real-time or inline monitoring. Reagent-Based Spectroscopy methods can also involve the use of consumable reagents and require analysis time, adding to operational cost and reducing throughput.

Accordingly, there is a need for an improved H₂O₂ measurement approach that delivers high accuracy and specificity without requiring substantial reagents, extensive sample preparation, or significant analysis time.

### SUMMARY

The disclosed subject matter provides techniques that improve the accuracy, reliability, and efficiency of H₂O₂ concentration measurements, particularly in the context of inline or near-line process monitoring within systems in certain typical chemical product line. Such techniques secure stability and rapidity without the drawbacks associated with certain traditional measurement methods.

In one aspect, the disclosed subject matter provides systems for measuring hydrogen peroxide (H₂O₂) concentration in a process solution. An example system includes a non-reagent module configured to continuously generate a first H₂O₂ concentration measurement result using a reagent-free detection measurement, a reagent-based module configured to intervalley generate a second H₂O₂ concentration measurement result using a reagent-involving measurement, a fluidic unit configured to provide the process solution to both the non-reagent analytical module and the reagent-based analytical module, and a processing unit configured to calibrate the first H₂O₂ concentration measurement at each interval of the second H₂O₂ concentration measurement.

In certain embodiments, the non-reagent module comprises a spectroscopic detector selected from the group consisting of ultraviolet-visible (UV-VIS) spectroscopy, near-infrared (NIR) spectroscopy, and Raman spectroscopy (RS). The reagent-based module comprises a titration system or a reagent-assisted spectroscopy unit.

In certain embodiments, the fluidic interface comprises a recirculation line that supplies a spike sample of the process solution to both modules. The processing unit is configured to determine a bias value between the first and second H₂O₂ concentration measurements and apply the bias value to adjust subsequent measurements by the non-reagent module.

In certain embodiments, the processing unit is configured to update the bias value periodically based on a predefined measurement interval of the reagent-based module. The processing unit is further configured to store measurement data and generate alerts when the calibrated H₂O₂ concentration exceeds a control limit.

The disclosed subject matter also provides methods for measuring hydrogen peroxide (H₂O₂) concentration in a process solution. An example method includes measuring a first H₂O₂ concentration using a reagent-free detection measurement, measuring a second H₂O₂ concentration using a reagent-based detection measurement, comparing the first and second H₂O₂ concentrations obtained at substantially the same time, and adjusting the first H₂O₂ concentration based on the second H₂O₂ concentration.

In certain embodiments, the method further includes calculating a bias value between the first and second H₂O₂ concentrations and applying the bias value to calibrate subsequent measurements. In certain embodiments, the method further includes updating the bias value at regular time intervals.

In certain embodiments, the reagent-free detection measurement comprises spectroscopy selected from the group consisting of UV-VIS, NIR, and Raman. The reagent-based detection measurement comprises titration or reagent-assisted spectroscopy.

In certain embodiments, the method further includes setting control limits and generating an alert when the adjusted H₂O₂ concentration measurement falls outside the control limits. The method further includes validating the linearity of the measurement system based on a coefficient of determination (R²).

### BRIEF DESCRIPTION OF THE DRAWINGS

Reference will now be made in detail to the various exemplary embodiments of the disclosed subject matter, which are illustrated in the accompanying drawings. The accompanying drawings, where like reference numerals refer to identical or functionally similar elements throughout the separate views, serve to further illustrate various embodiments and to explain various principles and advantages all in accordance with the disclosed subject matter.

FIG. 1 provides a schematic diagram of an exemplary system for measuring H₂O₂ concentration in a process solution in an embodiment of the disclosed subject matter.

FIG. 2 provides a graph showing a distribution for H₂O₂ concentration measurement data point in an embodiment of the disclosed subject matter.

FIG. 3A provides a graph showing a spectrum plot for H₂O₂ concentration measurements with various spike concentrations in an embodiment of the disclosed subject matter; FIG. 3B provides a graph showing a linearity between measured and expected data for H₂O₂ concentration in an embodiment of the disclosed subject matter.

It is to be understood that both the foregoing general description and the following detailed description are exemplary and are intended to provide further explanation of the disclosed subject matter.

### DETAILED DESCRIPTION

The disclosed subject matter provides techniques that improve the accuracy, reliability, and efficiency of H₂O₂ concentration measurements by integrating a reagent module to validate measurements made using a non-reagent module.

The terms used in this specification generally have their ordinary meanings in the art, within the context of the disclosed subject matter and in the specific context where each term is used. Certain terms are discussed below, or elsewhere in the specification, to provide additional guidance to the practitioner in describing the compositions and methods of the disclosed subject matter and how to make and use them. For purposes of interpreting this specification, the following definitions will apply and whenever appropriate, terms used in the singular will also include the plural and vice versa.

The term “non-reagent module” refers to an analytical subsystem configured to measure hydrogen peroxide (H₂O₂) concentration without the substantial use of chemical reagents. This module typically relies on spectroscopic techniques such as ultraviolet-visible (UV-VIS), near-infrared (NIR), or Raman spectroscopy to provide fast, inline or near-line measurements of H₂O₂ levels in a process stream. The term “reagent module” refers to an analytical subsystem that measures H₂O₂ concentration using reagent-based chemical reactions. This module may include titration systems or reagent-assisted spectroscopic methods and is used to obtain high-accuracy, low-bias measurement data, albeit at a lower sampling frequency due to cost and time constraints.

The term “bias correction” refers to the process of adjusting the output of the non-reagent module based on a comparison with the reagent module's measurement. The difference (or Delta) between the two concurrent measurements is calculated and applied to subsequent non-reagent measurements to enhance accuracy.

The term “delta value” refers to the numerical difference between the hydrogen peroxide concentration measured by the reagent module and that measured by the non-reagent module at substantially the same time point. This value is used to determine and apply a correction factor to the non-reagent module's future outputs.

The term “recirculation line” refers to a section of process flowing through which a sample, e.g., a process solution, of the wet clean solution is continuously or periodically routed, enabling sampling access by both analytical modules. The recirculation line ensures that both modules analyze effectively identical samples of the process chemistry.

The term “control limit” refers to a predefined threshold that defines the acceptable upper and lower bounds of hydrogen peroxide (H₂O₂) concentration in a process stream. Measurements that fall outside of these control limits may indicate a deviation from expected process conditions and can trigger alarms, corrections, or process interventions.

The term “interval” or “time interval” refers to the time period between consecutive measurements taken by a particular analytical module. For the reagent module, the sampling interval is typically longer and configurable based on reagent cost, accuracy requirements, or system performance. For the non-reagent module, the sampling interval is much shorter, allowing near-continuous monitoring.

The term “inline measurement” refers to the real-time analysis of a process chemical, such as H₂O₂, directly within the fluidic pathway of a production system. Inline measurements are conducted without removing samples from the system, enabling fast response and feedback without interrupting the process flow.

The term “validation cycle” refers to the periodic sequence wherein the reagent module performs a reference measurement that is used to calibrate or adjust the non-reagent module's output. Each validation cycle results in a bias correction being calculated and applied, maintaining system-wide measurement integrity.

The term “peroxide spike concentration” refers to a deliberately elevated concentration of hydrogen peroxide (H₂O₂) introduced into a chemical system or test sample to evaluate the response, linearity, and accuracy of an analytical measurement method. For validation in certain embodiments, peroxide spikes are used to simulate a range of concentration levels, verify a measurement system/method performance, and confirm that the system/method can reliably detect and quantify changes in H₂O₂ levels without saturation, distortion, or nonlinearity. This controlled spiking allows assessment of both the dynamic range and the calibration integrity of the measurement modules.

The term “linearity” refers to the degree to which the output of a measurement system is directly proportional to the true value of the analyte across a specified concentration range. High linearity ensures that the sensor or method produces predictable and accurate readings across its entire operating range.

The term “R²” (coefficient of determination) refers to a statistical metric that quantifies how well a linear regression model fits the observed data. In peroxide detection, R² reflects the goodness-of-fit between measured concentrations and their corresponding known (spiked) concentrations. An R² value close to 1.0 indicates near-perfect linearity, meaning that nearly all variation in the measured data can be explained by changes in actual peroxide concentration.

The disclosed subject matter provides techniques for measuring hydrogen peroxide (H₂O₂) concentration in wet cleaning solutions, particularly for semiconductor process applications where fast response time and high measurement accuracy are both critical. The disclosed approach enables the integration of a fast-response, non-reagent-based analytical module with a high-accuracy, reagent-based validation module. This dual-module design leverages the strengths of both technologies to overcome limitations associated with existing techniques.

### System Architecture

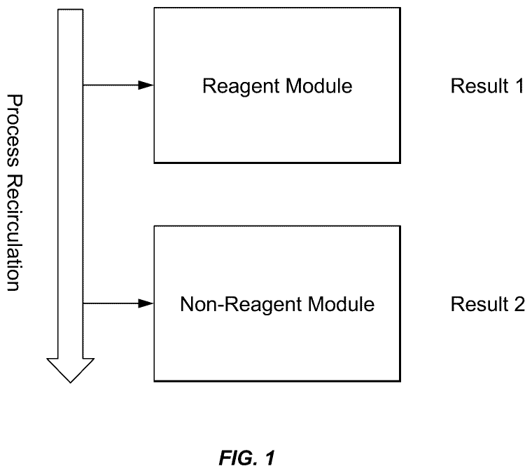

With reference to FIG. 1, the system 100 includes two independent analytical modules: non-reagent 102 module and reagent module 104. This non-reagent module 102 employs a spectroscopy-based technique, such as UV-VIS, NIR, or Raman spectroscopy, to perform rapid, continuous, or near-continuous monitoring of H₂O₂ concentration. These above methods offer fast measurement times and are well-suited for real-time process monitoring but generally lack the accuracy required for tight control in high-specification applications due to interferences or sensitivity limitations. Selectively, the reagent module 104 is coupled with the non-reagent module 102. The reagent module 10 can use a reagent-involving method, such as titration or reagent-assisted UV-VIS spectroscopy, to periodically perform high-accuracy H₂O₂ measurements, providing reliable concentration values, while these methods are slower and require consumables. Further, the system 100 includes a fluidic unit and a processing unit (not shown in FIG. 1), which are configured to provide the process solution to both the non-reagent analytical module and the reagent-based analytical module and a processing unit configured to calibrate the first H₂O₂ concentration measurement at each interval of the second H₂O₂ concentration measurement, respectively.

Both non-reagent module1 102 and reagent module 104 are configured to draw samples from the same process solution, typically from a recirculation line 106, where the drawn solution composition remains effectively constant between measurements taken at nearly the substantially same time. Such a dual-module measurement system is designed to enhance the accuracy of hydrogen peroxide (H₂O₂) concentration monitoring in a process recirculation loop.

### Measurement Workflow

During a typical operation, the non-reagent module 102 can performs fast, successive measurements of H₂O₂ concentration. At predefined time intervals, the reagent module 104 also performs a measurement. The system 100 can further a validation module 108 configured to execute a comparison between the measurement results from the non-reagent module 102 (first H₂O₂ concentration measurement, featured with Result1) and the corresponding result from the reagent module 104 (second H₂O₂ concentration measurement, featured with Result2), where the Result2 can be treated by validation module 108 as a calibration reference due to its superior accuracy. If a deviation (bias) is detected between the two results, validation module 108 can calculate a correction factor. This bias can be then used to adjust the output of the non-reagent module 102, thereby improving the accuracy of subsequent measurements without increasing reagent consumption or slowing analysis throughput overall.

In certain embodiments, the correction factor can include a delta (Δ) value is calculated as the difference between Result1 and Result2 (e.g., Δ=Result2−Result1). whenever both measurements are available simultaneously. This delta is used to calibrate or bias the output of the non-reagent module 102, thereby improving its accuracy in subsequent readings.

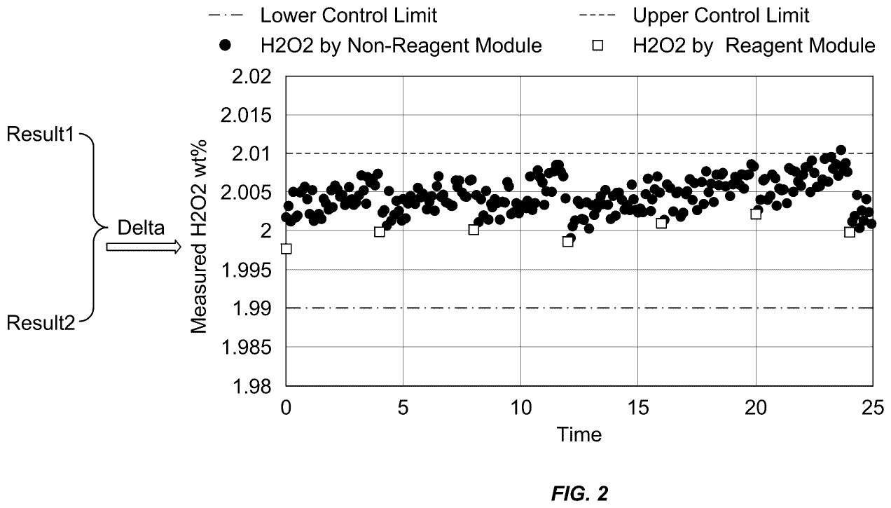

FIG. 2 illustrates a time-series graph plots measured H₂O₂ concentrations (wt. %) over time. There are two sets of data points corresponding to two results obtained by the two modules, respectively, where the round dots represent values obtained by the non-reagent module 102, while the squares correspond to periodic measurements from the reagent module 104, where it can be observed the squares are interval along over the time due to interval measurements by the reagent module 104. The two data points are bounded by two lines indicating the upper and lower control limits. The plot shows that the non-reagent module 102 provides high-frequency data with minor fluctuations, while the reagent module 104 provides interval data but with accurate reference points. It demonstrates a consistent alignment between the square data points and the average of the round data points, after delta correction, described below. FIG. 2 validates that the dual-module system 100 can achieve both real-time monitoring and high measurement fidelity and effectively supports that the subject matter secures an advantage of combining measurement rapidity with accuracy through calibration feedback. The processing unit can store measurement data and generate alerts when the calibrated H₂O₂ concentration exceeds a control limit. For example, when measurement data falls outside of the upper and lower control limits, the alerts will be generated.

The non-reagent module 102 continues its measurements using the corrected bias until the next scheduled measurement by the reagent module 104 is obtained. The time interval between reagent-based measurements can be adjusted based on factors accordingly, such as process control requirements, acceptable levels of reagent consumption, and equipment performance.

This hybrid measurement approach disclosed by the subject matter enables the following but not limiting to, technical advantages: The non-reagent module accuracy is dynamically corrected using high accurate data from the reagent module; the system retains the real-time or near-real-time capability of spectroscopy methods; the reagent module can operate at reduced frequency, lowering reagent costs while still maintaining accuracy over time; both modules sample from the same solution line, ensuring data consistency and integrity.

In certain embodiments for implementation, the non-reagent module 102 can include an inline UV-VIS spectrometer configured for continuous monitoring. Further, the reagent module 104 can include an automated titration unit scheduled to run at a time interval, e.g., every 10, 20, or 30 minutes, which increases measurement accuracy with a controllable cost-savings and workflow simplification. At each titration interval, a control algorithm can compare the spectrometer output from the non-reagent module 102 with the titration result from the reagent module 104 and update a bias correction parameter in the spectrometer control system. Subsequent UV-VIS readings are then adjusted according to the bias correction.

This feedback loop ensures that the spectrometer remains calibrated without requiring constant manual intervention, enabling the system 100 to deliver high-fidelity process control with minimized operational overhead.

In certain embodiments for peroxide detection in Semiconductor Clean Chemistry, experimental results from the system and method provided by the subject matter demonstrate the experimental validation and conceptual design of a dual-module hydrogen peroxide (H₂O₂) detection system used in practical process applications, e.g., Post Etch Residual Removal Clean Chemistry, within semiconductor wet cleaning processes. In one example, the H₂O₂ predetermined concentration for peroxide samples, e.g., with spike concentrations, varies from 0% to 4%, for a reagent spectroscopy method implemented in the example. Table 1 lists the experimental data for the example.

TABLE 1

| H₂O₂ Expected | H₂O₂ Measured | Std. Dev | Accuracy |
|---|---|---|---|
| (wt. %) | (wt. %) | (wt. %) | (wt. %) |
| 0 | 0.008 | 0.002 | 0.008 |
| 1.047 | 1.033 | 0.002 | −0.015 |
| 2.066 | 2.056 | 0.001 | −0.011 |
| 3.036 | 3.068 | 0.001 | 0.033 |
| 4.091 | 4.076 | 0.002 | −0.016 |

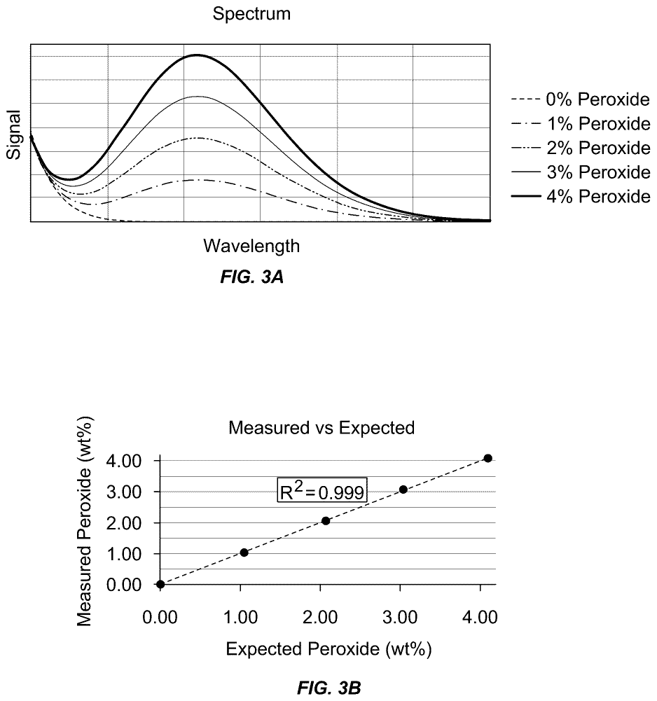

With reference to FIG. 3A and FIG. 3B, the diagram schematically shows measurement curve for H₂O₂ samples with various concentrations under reagent spectroscopy measurement. It can be observed that the spectrum signal becomes stronger with an increase of H₂O₂ concentration in samples (Shown in FIG. 3A). As shown in FIG. 3B, the experimental measured data of the system is substantially proportional to the expected data of the H₂O₂ spike concentrations across a specified concentration range, demonstrating an excellent linearity and accuracy with Peroxide spike concentration. Specifically, the coefficient of determination (R²) in the example, which has a value close to 1.0, indicates near-perfect linearity, validating that nearly all variation in the measured data can be explained by changes in actual peroxide concentration. The experimental results in Post Etch Residual Removal Clean Chemistry detection example can demonstrate that the disclosed system and method applied in the subject matter is highly consistent and suitable for quantitative analysis with reliability and accuracy.

In addition to the various embodiments depicted and claimed, the disclosed subject matter is also directed to other embodiments having other combinations of the features disclosed and claimed herein. As such, the features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

What we claim is:

1. A system for measuring hydrogen peroxide (H₂O₂) concentration in a process solution, comprising:
a non-reagent module configured to continuously generate a first H₂O₂ concentration measurement result using a reagent-free detection measurement;
a reagent-based module configured to intervally generate a second H₂O₂ concentration measurement result using a reagent-involving measurement;
a fluidic unit configured to provide the process solution to both the non-reagent analytical module and the reagent-based analytical module; and
a processing unit configured to calibrate the first H₂O₂ concentration measurement at each interval of the second H₂O₂ concentration measurement.

2. The system of claim 1, wherein the non-reagent module comprises a spectroscopic detector selected from the group consisting of ultraviolet-visible (UV-VIS) spectroscopy, near-infrared (NIR) spectroscopy, and Raman Spectroscopy (RS).

3. The system of claim 1, wherein the reagent-based module comprises a titration system or a reagent-assisted spectroscopy unit.

4. The system of claim 1, wherein the fluidic interface comprises a recirculation line that supplies a spike sample of the process solution to both modules.

5. The system of claim 1, wherein the processing unit is configured to determine a bias value between the first and second H₂O₂ concentration measurements and apply the bias value to adjust subsequent measurements by the non-reagent module.

6. The system of claim 5, wherein the processing unit is configured to update the bias value periodically based on a predefined measurement interval of the reagent-based module.

7. The system of claim 1, wherein the processing unit is further configured to store measurement data and generate alerts when the calibrated H₂O₂ concentration exceeds a control limit.

8. A method for measuring hydrogen peroxide (H₂O₂) concentration in a process solution, comprising:
measuring a first H₂O₂ concentration using a reagent-free detection measurement;
measuring a second H₂O₂ concentration using a reagent-based detection measurement;
comparing the first and second H₂O₂ concentrations obtained at substantially the same time; and
adjusting the first H₂O₂ concentration based on the second H₂O₂ concentration.

9. The method of claim 8, further comprising calculating a bias value between the first and second H₂O₂ concentrations and applying the bias value to calibrate subsequent measurements.

10. The method of claim 8, further comprising updating the bias value at regular time intervals.

11. The method of claim 8, wherein the reagent-free detection measurement comprises spectroscopy selected from the group consisting of UV-VIS, NIR, and Raman.

12. The method of any of claim 8, wherein the reagent-based detection measurement comprises titration or reagent-assisted spectroscopy.

13. The method of claim 8, further comprising setting control limits and generating a alert when the adjusted H₂O₂ concentration measurement falls outside the control limits.

14. The method of claim 8, further comprising validating the linearity of the measurement system based on a coefficient of determination (R²).
